(19) United States
(12) Patent Application Publication
(10) Pub. No.: US 2016/0342839 A1
(43) Pub. Date: Nov. 24, 2016

(54) IDENTIFYING ELECTRONIC COMPONENTS FOR AUGMENTED REALITY

(71) Applicant: HEWLETT PACKARD ENTERPRISE DEVELOPMENT LP, Houston, TX (US)

(72) Inventor: Jonathan Condel, Boise, ID (US)

(21) Appl. No.: 15/114,748

(22) PCT Filed: Mar. 20, 2014
(86) PCT No.: PCT/US14/31292

§ 371 Date: Jul. 27, 2016

(51) Int. Cl. G06K 9/00; G08B 5/38; G06T 19/00

(52) U.S. Cl. CPC G06K 9/00671; G06T 19/006; G08B 5/38; G06K 2209/19

(57) ABSTRACT

Techniques for identifying electronic components for augmented reality are described in various implementations. In one example implementation, a method may include causing a first changeable visual indicator of a first electronic component to change according to a defined pattern. The method may also include capturing images that depict the first electronic component and other electronic components within a field of view of the image capture mechanism, and analyzing the captured images to identify the first electronic component from among the other electronic components based on the first changeable visual indicator changing according to the defined pattern. The method may also include presenting an augmented reality scenario associated with the first electronic component, the augmented reality scenario being presented as a visual overlay to the captured images.

### BACKGROUND

Businesses and other organizations that gather and manage large amounts of data have generally followed a trend of employing more and more computing, storage, and networking resources to analyze, store, and/or distribute such data. These electronic resources may be housed in enclosures and/or racks along with other equipment of the same or of varying types. For example, a rack in a server room or in a datacenter may house multiple single or multi-node servers and one or more networking devices that allow the servers to communicate with one another or with other nodes in the network. As another example, some disk-based storage systems may house tens, hundreds, or even thousands of drives in rack-mounted enclosures.

Support technicians may generally be tasked with maintaining the electronic resources, and in the case of failures, may be called upon to fix or replace the failed resources. In some cases, the electronic resources may include one or more field replaceable units, which may allow removal and replacement of a particular type of component with a backup or spare unit. Such units are often hot-swappable, meaning that the unit may be removed and replaced while other portions of the system remain functional—i.e., one or more failed units may be replaced without shutting down the system.

### BRIEF DESCRIPTION OF THE DRAWINGS

FIGS. 1A and 1B are conceptual diagrams showing examples of a component servicing environment in accordance with implementations described herein.

FIG. 2 is a block diagram of an example discovery and augmented reality system in accordance with implementations described herein.

FIG. 3 is a swim lane diagram of an example process for discovering electronic components in accordance with implementations described herein.

FIG. 4 is a block diagram of an example computing system for mapping electronic components and presenting augmented reality scenarios in accordance with implementations described herein.

FIG. 5 is a flow diagram of an example process for identifying an electronic component and presenting an augmented reality scenario associated with the identified electronic component in accordance with implementations described herein.

FIG. 6 is a block diagram of an example computing system that includes a computer-readable storage medium with instructions to identify electronic components for augmented reality in accordance with implementations described herein.

### DETAILED DESCRIPTION

As computing and storage systems grow in size and complexity, it becomes increasingly difficult for support technicians to efficiently and effectively maintain the systems for which they are responsible. The technicians may make mistakes in identifying the specific resource to be serviced and/or in performing the appropriate action once the resource has been identified. Such mistakes can lead to system outages, data loss, or other undesirable outcomes.

The techniques described herein may serve to reduce the occurrence of such mistakes by providing user-friendly mechanisms for identifying the specific resources that are in need of service, and providing the technicians with up-to-date, interactive information associated with servicing the resource. As described in greater detail below, a support technician may be equipped with a user computing device, such as a tablet, smartphone, or other mobile device that communicates with a system that is reporting a problem with one or more of its components. The user computing device may be used to capture images of the system that is reporting the problem, e.g., using a built-in camera of the computing device, and to identify identify the components captured in the images. The components may visually identify themselves to the user computing device by changing a visual indicator according to a defined pattern. For example, one or more light emitting diodes (LEDs) on the components may flash at a particular frequency for a period of time, and such pattern may be captured in the images and used to identify the component to the user computing device. Other components within the field of view of the user computing device may similarly identify themselves, and the user computing device may generate a map of the various components within its field of view.

The user computing device may then be used to present an augmented reality scenario as a visual overlay to the captured images. The augmented reality scenario may include static and/or dynamic information associated with one or more of the identified components, and may assist the support technician in servicing the components.

As such, the techniques described herein may, in some implementations, allow a support technician to more easily identify specific electronic components from among other electronic components in an operating environment, and provide the support technician with augmented reality service assistance associated with the identified electronic components.

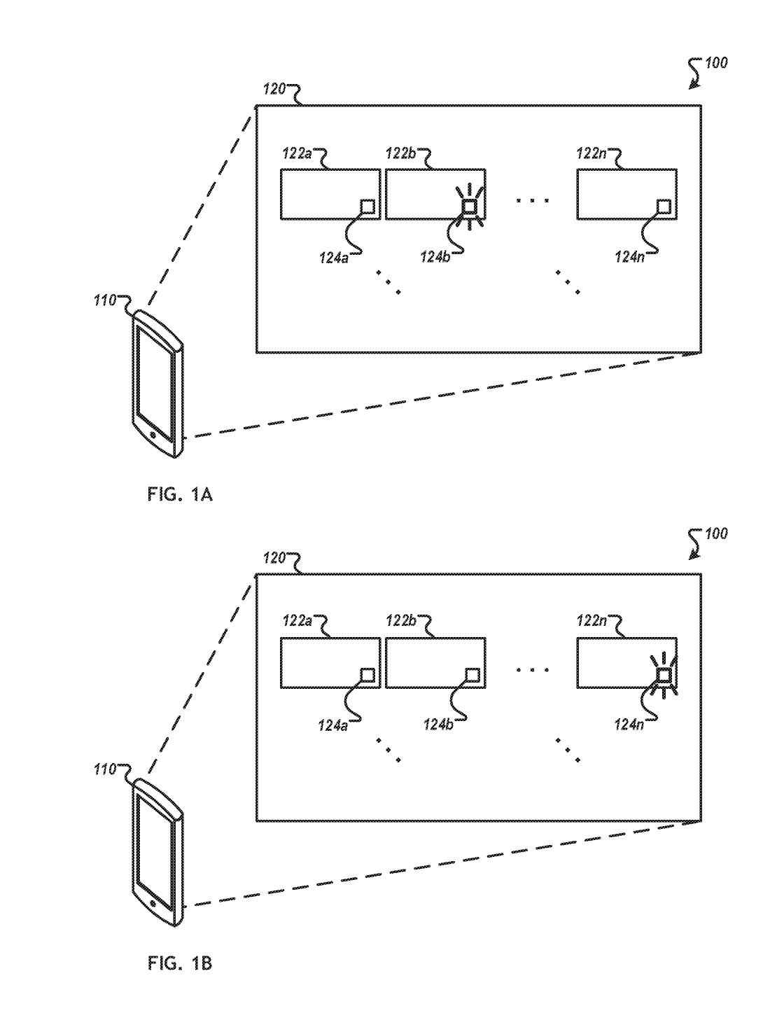

Referring to the drawings, FIGS. 1A and 1B are conceptual diagrams showing examples of a component servicing environment 100. The example topology of environment 100 may be representative of various component servicing environments, such as those encountered in a server room or in a datacenter, in which multiple computing systems having multiple electronic components may be housed. However, it should be understood that the example topology of environment 100 is shown for illustrative purposes only, and that various modifications may be made to the configuration. For example, environment 100 may include different or additional components, or the components may be implemented in a different manner than is shown.

In the context of this document, the term electronic system should be understood broadly to include any electronic product or system having multiple serviceable electronic components. As such, the term electronic system may include, for example, a server, a disk array, a network appliance, a printer, or other appropriate system or group of systems. The electronic components of a system may be housed in a single enclosure or in multiple enclosures, and may be housed in a single rack or may be distributed across multiple racks.

The component servicing environment 100 is shown at two different points in time. At both points in time, a user computing device 110 is positioned to capture images of an electronic system 120 that includes multiple electronic components 122a, 122b, and 122n (collectively electronic components 122). The user computing device 110 may, in practice, be any appropriate type of mobile computing device, such as a tablet, a smartphone, a laptop computer, or the like, such that a technician may carry the device to a location of a troubled electronic system within the environment.

To capture images of the electronic system 120, the user computing device 110 may include an image capture mechanism (not shown) configured to capture video images (i.e. a series of sequential video frames) at any desired frame rate, or to take still images, or both. The image capture mechanism may be a still camera, a video camera, or other appropriate type of device that is capable of capturing images. For example, the image capture mechanism may include a built-in camera of the user computing device 110. The image capture mechanism may be configured to trigger image capture on a continuous, periodic, or on-demand basis. The image capture mechanism may capture a view of the entire field of view, or a portion of the field of view (e.g. a physical region, black/white versus color, etc.) as appropriate. As used herein, an image is understood to include a snapshot, a frame or series of frames (e.g., one or more video frames), a video stream, or other appropriate type of image or set of images. In environment 100, the user computing device 110 may be positioned to capture the entire electronic system 120 within the field of view of the image capture mechanism, or may be positioned to capture a portion of the electronic system 120.

Each of the multiple electronic components to be identified may include a changeable visual indicator 124a, 124b, and 124n (collectively changeable visual indicators 124). The changeable visual indicators 124 may include any appropriate numbers and/or types of devices that can be controlled electronically to change in visual appearance in response to electronic commands. The changeable visual indicators 124 may be positioned, for example, on front-facing portions of the electronic components 122, or in another location such that they may be observed by the user computing device 110. One example of a changeable visual indicator may be a light emitting diode (LED) that may be flashed off and on and/or illuminated using different brightness or color settings. Another example of a changeable visual indicator may be multiple LEDs that may each be independently changeable. Yet another example of a changeable visual indicator may be a display screen, such as a liquid crystal display (LCD) or other appropriate display. At the point in time illustrated in FIG. 1A, a changeable visual indicator 124b (e.g., an LED) of electronic component 122b is shown as illuminated or flashing. At the point in time illustrated in FIG. 1B, a changeable visual indicator 124n (e.g., an LED) of electronic component 122n is shown as illuminated or flashing.

In practice, the user computing device 110 may cause the changeable visual indicators 124 to change according to defined patterns. For example, the user computing device 110 may send appropriate commands to the electronic system 120 requesting that the changeable visual indicators 124 flash on and off at a particular frequency. The individual changeable visual indicators 124a, 124b, and 124n may be caused to change sequentially, e.g., one at a time, or may be caused to change in parallel, e.g., at the same time. The defined patterns may be similar, e.g., all changeable visual indicators changing in a similar manner, or the patterns may be different, e.g., each changeable visual indicator changing in a unique manner.

The user computing device 110 may capture images, e.g., over time, that depict the electronic components 122 within a field of view of the device. As shown in FIGS. 1A and 1B, the field of view of the device includes electronic components 122a, 122b, and 122n, but it should be understood that more or fewer electronic components may be captured in the images. The user computing device 110 may analyze the captured images to identify specific electronic components in the captured images based on the changeable visual indicators 124 changing according to the defined patterns. For example, during a period of time when the changeable visual indicator 124b of electronic component 122b is flashing at a frequency of three hertz (as illustrated in FIG. 1A), images captured during that time period may be analyzed to identify which of the visual indicators was changing according to the defined pattern, and the user computing device 110 may then recognize electronic component 122b from among the other electronic components depicted in the image. Similarly, during a period of time when the changeable visual indicator 124n of electronic component 122n is flashing at a frequency of three hertz (as illustrated in FIG. 1B), images captured during that time period may be analyzed to identify which of the visual indicators was changing according to the defined pattern, and the user computing device 110 may then recognize electronic component 122b from among the other electronic components depicted in the image. In some implementations, the user computing device 110 may generate a live mapping of multiple electronic components 122, including their relative positioning within the images. For example, the live mapping of the electronic components 122 may indicate that electronic component 122a is located to the left of and adjacent to electronic component 122b. As the user computing device 110 is moved with respect to the electronic components 122, the relative positioning information would remain the same.

After the user computing device 110 has identified one or more of the electronic components 122, the device may present an augmented reality scenario associated with any one or more of the identified electronic components 122. The augmented reality scenario may he displayed as a visual overlay to the captured images, and may include information about one or more of the identified components and/or information associated with servicing such components. The information displayed in the augmented reality scenario may include static and/or dynamic information. For example, in some implementations, different color overlays may be used to provide dynamic status information associated with the respective components (e.g., healthy components shown in green; unhealthy, but still functioning components shown in yellow; failed components shown in red; etc.). In some implementations, various service-related operations may be provided in the augmented reality scenario, including replacement part ordering, technical manual visualizations, repair videos, event log access, or other appropriate operations. The augmented reality scenarios may be configurable and/or implementation-specific, and different or similar augmented reality scenarios may be presented for different types of identified electronic components.

In some implementations, the position of the user computing device 110 need not remain fixed with respect to the electronic system 120 and/or the electronic components 122. Indeed, the user computing device 110 may be rotated or translated in space along any axis or along multiple axes. As such, the device may be tilted, or may he moved nearer to or farther from the electronic system 120, or may be jiggled, as long as the electronic system 120 (or at least the portion intended to be captured) remains in view of the camera. Regardless of such movement, the user computing device 110 may be able to identify and track the location of the electronic components 122 in the images as described above.

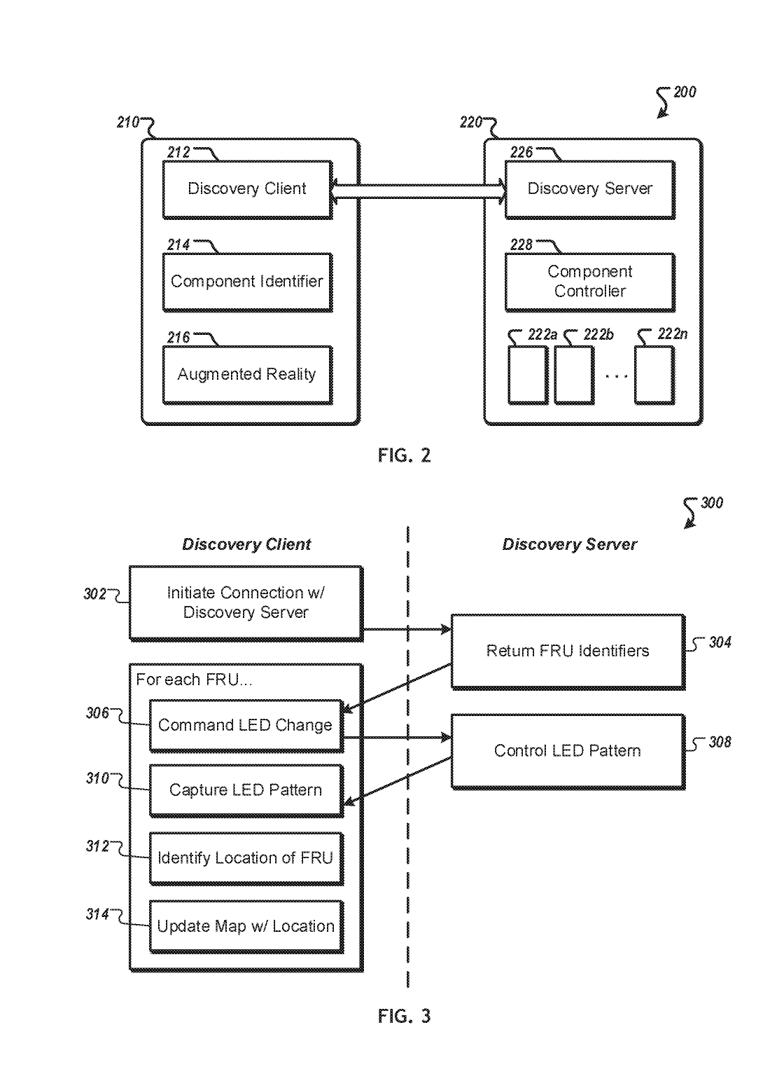

FIG. 2 is a block diagram of an example discovery and augmented reality system 200. System 200 may, in some implementations, be used to perform portions or all of the functionality described above with respect to the user computing device 110 and electronic system 120 of FIGS, 1A and 1B. However, it should be understood that system 200 may include any appropriate types of computing and/or electronic devices. System 200 may also include groups of appropriate computing and/or electronic devices, and portions or all of the functionality may be performed on a single device or may be distributed amongst different devices.

As shown, system 200 includes a computing device 210 and an electronic system 220. The computing device 210 includes a discovery client 212, a component identifier 214, and an augmented reality engine 216. The electronic system 220 includes a discovery server 226, a component controller 228, and multiple electronic components 222a, 222b, and 222n (collectively electronic components 222). It should be understood that the components shown here are for illustrative purposes, and that in some cases, the functionality being described with respect to a particular component may be performed by one or more different or additional components. Similarly, it should be understood that portions or all of the functionality may be combined into fewer components than are shown.

The computing device 210 may be configured to electronically communicate with the electronic system 220 using one or more appropriate communications protocols. For example, computing device 210 and electronic system 220 may communicate via one or more wired or wireless networking protocols, near-field communication protocols. Bluetooth protocols, or other appropriate communications protocols or groups of protocols.

The discovery client 212 may initiate communication with the discovery server 226, and may request that the discovery server 226 identify the various electronic components 222 included as part of the electronic system 220. The discovery server 226 may maintain a component manifest, which may include static and/or dynamic information associated with each of the components of the system. The component manifest may be stored, for example, in a local or remote database, and may include information such as part numbers, serial numbers, worldwide identifiers, current state (e.g., functioning, failing, failed, unsafe to replace, safe to replace, etc.), event logs, repair history, and other appropriate information associated with the electronic components 222.

In response to the request, the discovery server 226 may query its component manifest and respond by identifying all or certain of the components to the discovery client 212. For example, the discovery server 226 may respond by sending a set of all component identifiers to the discovery client 212, or may respond by sending a set of the component identifiers that have a particular status (e.g., failing or failed).

Then, for each of the component identifiers returned to the discovery client 212, the client may command a changeable visual indicator of the component to change in a defined pattern, and may capture images of the changeable visual indicator changing in the defined pattern. Component controller 228 may be in electronic communication with the computing device 210, e.g., either directly or via the discovery server 226, and may carry out the commands to change the changeable visual indicators using appropriate signals to control the indicators on the electronic components 222. In some implementations, the component controller 228 may change the visual indicators sequentially such that the visual indicators are changed according to the defined patterns one at a time. In other implementations, the component controller 228 may change the visual indicators in parallel such that the visual indicators are changed according to the defined patterns all at the same time, or a subset of the visual indicators may be changed at the same time. When the visual indicators are changed sequentially, the visual indicators may be changed in a similar pattern, e.g., each changeable indicator changing according to a like defined pattern. When the visual indicators are changed in parallel, the visual indicators may be changed in different patterns, e.g., each changeable indicator changing according to a unique defined pattern.

Component identifier 214 may be configured to analyze captured images of the changing visual indicators and to identify the electronic components 222 in the images based on the indicators changing according to the defined patterns. For example, when the visual indicators are changed sequentially, the component identifier 214 may identify the components one at a time by identifying the component having a visual indicator changing according to the expected defined pattern (e.g., flashing on and off at a particular frequency) at a time when the particular component is being commanded to flash the expected pattern. When the visual indicators are changed in parallel, the component identifier 214 may identify the components substantially at the same time by matching the unique patterns of indicator changes to the respective components. For example, an indicator of component 222a may flash on and off at a frequency of three hertz, an indicator of component 222b may flash on and off at a frequency of six hertz, and an indicator of component 222n may flash on and off at a frequency of nine hertz, all at the same time. Similarly, different frequencies of flashing or other unique visually identifiable patterns may be used. In such cases, the component identifier 214 may distinguish the various components from one another based on the specific pattern that is being exhibited, with each pattern being associated with a specific one of the components.

After component identifier 214 has identified one or more of the electronic components 222, augmented reality engine 216 may generate and present an augmented reality scenario associated with any one or more of the identified electronic components 222. The augmented reality scenario may be displayed as a visual overlay to the captured images, and may include information about one or more of the identified components and/or information associated with servicing such components. The augmented reality scenarios may be configurable and/or implementation-specific, and different or similar augmented reality scenarios may be presented for different types of identified electronic components.

FIG. 3 is a swim lane diagram of an example process 300 for discovering electronic components. The process 300 may be performed, for example, by the discovery client 212 and the discovery server 226 illustrated in FIG. 2. For clarity of presentation, the description that follows uses the discovery client 212 and the discovery server 226 as the basis of an example for describing the process. However, it should be understood that other systems, or combination of systems, may be used to perform the process or various portions of the process.

Process 300 begins at block 302 when the discovery client 212 initiates a connection with the discovery server 226. The connection may be initiated using any appropriate communications protocol or protocols. At block 304, the discovery server 226 may respond by returning identifiers of all or portions of the field replaceable units (FRUs) associated with electronic system 220.

For each of the FRU identifiers returned, the discovery client 212 may issue a command to change an LED of the FRU (at block 306), e.g., according to a defined pattern. The discovery server 226 may receive such commands and control the LEDs of the FRU to change according to the defined pattern (at block 308). In various implementations, the LED changing commands and/or the corresponding controls may be issued sequentially or in parallel.

The discovery client 212 may capture the LEDs changing according to the defined pattern (at block 310), and may identify a location of the FRU in the image based on the LED of the given FRU changing according to the defined pattern (at block 312). The identified location of the FRU may then be used to update a map of the relative locations of multiple FRUs (at block 314). The map may represent a complete live mapping of the FRUs visible in the field of view of the computing device 210. The map may then be used to generate and present one or more augmented reality scenarios associated with servicing one or more of the identified and mapped FRUs.

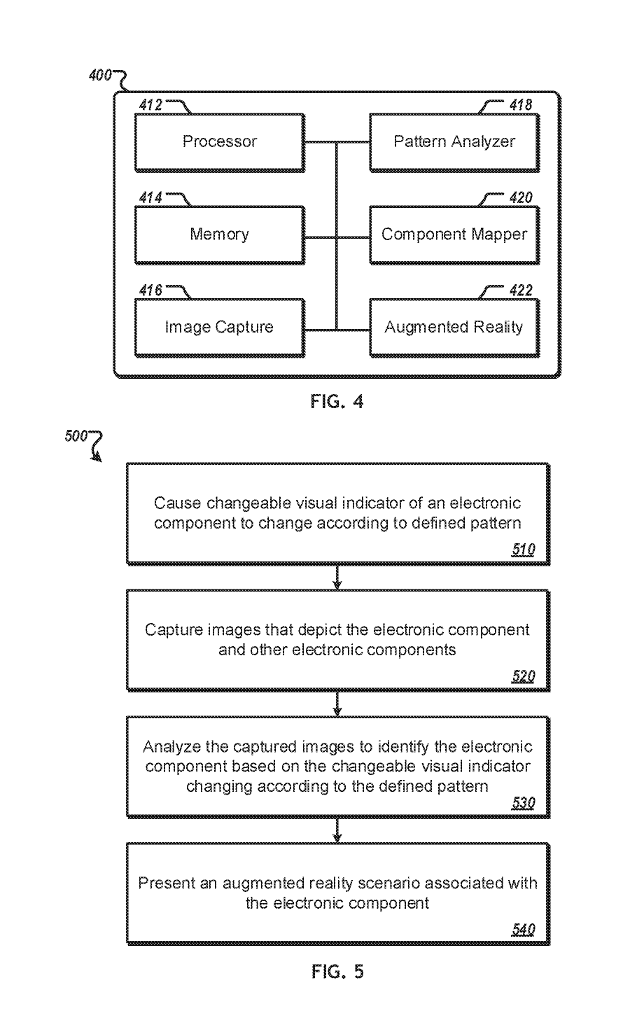

FIG. 4 is a block diagram of an example computing system 400 for mapping electronic components and presenting augmented reality scenarios. Computing system 400 may, in some implementations, be used to perform portions or all of the functionality described above with respect to the user computing device 110 of FIGS. 1A and 1B. However, it should be understood that the computing system 400 may also include groups of appropriate computing devices, and portions or all of the functionality may be performed on a single device or may be distributed amongst different devices.

As shown, the example computing system 400 may include a processor resource 412, a memory resource 414, an image capture device 416, a pattern analyzer module 418, a component mapper module 420, and an augmented reality module 422. It should be understood that the components shown here are for illustrative purposes, and that in some cases, the functionality being described with respect to a particular component may be performed by one or more different or additional components. Similarly, it should be understood that portions or all of the functionality may be combined into fewer components than are shown.

Processor resource 412 may be configured to process instructions for execution by the computing system 400. The instructions may be stored on a non-transitory tangible computer-readable storage medium, such as in memory resource 414 or on a separate storage device (not shown), or on any other type of volatile or non-volatile memory that stores instructions to cause a programmable processor to perform the techniques described herein. Alternatively. or additionally, computing system 400 may include dedicated hardware, such as one or more integrated circuits, Application Specific Integrated Circuits (ASICs). Application Specific Special Processors (ASSPs), Field Programmable Gate Arrays (FPGAs), or any combination of the foregoing examples of dedicated hardware, for performing the techniques described herein. In some implementations, the processor resource 412 may include multiple processors and/or types of processors, and the memory resource 414 may include multiple memories and/or types of memory.

Image capture device 416 may be implemented in hardware and/or software, and may be configured, for example, to capture images of an electronic system that includes a plurality of electronic components, each having a dynamic visual indicator. Image capture device 416 may be configured to capture video images (i.e. a series of sequential video frames) at any desired frame rate, or to take still images, or both. The image capture device 416 may be a still camera, a video camera, or other appropriate type of device that is capable of capturing images. The image capture device 416 may be configured to trigger image capture on a continuous, periodic, or on-demand basis. The image capture device 416 may capture a view of the entire field of view, or a portion of the field of view (e.g. a physical region, black/white versus color, etc.) as appropriate. As used herein, an image is understood to include a snapshot, a frame or series of frames (e.g., one or more video frames), a video stream, or other appropriate type of image or set of images.

Pattern analyzer module 418 may execute on processor resource 412, and may be configured to recognize respective patterns of changes in respective dynamic visual indicators. Pattern analyzer module 418 may identify patterns occurring in one or more dynamic visual indicators, either sequentially or in parallel. In some implementations, the pattern analyzer module 418 may include near-matching pattern recognition such that if a particular pattern of changes is not matched exactly, but is deemed to be close enough, the pattern analyzer module 418 may indicate a positive match. For example, if a particular pattern includes a sequence of ten events, and the pattern analyzer module 418 recognizes nine of the ten events as occurring in the captured images, then the pattern analyzer module 418 may recognize the nine events as being close enough to indicate a matching pattern. However, such near-matching may not be allowed in some implementations, and the “closeness” of the match required to recognize a particular pattern may be implementation-specific and/or configurable.

Component mapper module 420 may execute on processor resource 412, and may be configured to generate a mapping of the plurality of electronic components based on the recognized respective patterns of changes in the respective dynamic visual indicators. The mapping of the plurality of electronic components may include relative position information associated with the plurality of electronic components. In some implementations, the plurality of components may be mapped sequentially, with each dynamic visual indicator being changed according to a like pattern. In other implementations, the plurality of components may be mapped in parallel, with each dynamic visual indicator being changed according to a unique pattern.

Augmented reality module 422 may execute on processor resource 412, and may be configured to present an augmented reality scenario associated with at least one of the plurality of electronic components. The augmented reality scenario may be displayed as a visual overlay to the captured images, and may include information about one or more of the identified components and/or information associated with servicing such components. The augmented reality scenarios may be configurable and/or implementation-specific, and different or similar augmented reality scenarios may be presented for different types of identified electronic components.

In some implementations, augmented reality module 422 may be included as part of a mobile app that provides the augmented reality functionality described above. For example, the app may operate on appropriate computing systems to display a camera feed augmented with virtual objects that are superimposed in the camera feed. In the augmentation, the virtual objects may be presented as an overlay that appears to be positioned in front of a real-world background.

FIG. 5 is a flow diagram of an example process 500 for identifying an electronic component and presenting an augmented reality scenario associated with the identified electronic component. The process 500 may be performed, for example, by a mobile computing device such as the user computing device 110 illustrated in FIGS. 1A and 1B, or by computing system 400 illustrated in FIG. 4. For clarity of presentation, the description that follows uses the computing system 400 as the basis of an example for describing the process. However, it should be understood that another system, or combination of systems, may be used to perform the process or various portions of the process.

Process 500 begins when a changeable visual indicator of an electronic component is caused to be changed according to a defined pattern at block 510. For example, in some implementations, computing system 400 may send appropriate commands to the electronic component requesting that the changeable visual indicator of the electronic component flash on and off at a particular frequency.

In some implementations, the changeable visual indicator of the electronic component may include a single LED (e.g., a status LED on a disk drive) or multiple LEDs (e.g., a locate LED and a status LED on a disk drive), but other changeable visual indicators may also be used. The defined pattern may be configurable and implementation-specific. For example, in some implementations, the defined pattern may include flashing one or more LEDs at a specific frequency for a given period of time. In other implementations, the defined pattern may include changing the colors and/or brightness of one or more LEDs.

In some implementations, changeable visual indicators of other electronic components may also be caused to be changed according to the same defined pattern or according to different defined patterns. The individual changeable visual indicators may be caused to change sequentially, e.g., one at a time, or may be cause to change in parallel, e.g., at substantially the same time. The defined patterns may be similar, e.g., all changeable visual indicators changing in a similar manner, or the patterns may be different, e.g., each changeable visual indicator. changing in a unique manner.

At block 520, images that depict the electronic component and other electronic components are captured. The images may be captured over a period of time to ensure that any of the defined visual patterns from block 510 are captured in the images. In some implementations, the images may be continuously captured, e.g., as a video, during an extended period of time that includes a period of time before the visual indicators begin changing and a period of time after the visual indicators complete the defined pattern or patterns.

At block 530, the captured images are analyzed to identify the electronic component, e.g., from among the other electronic components depicted in the images. The electronic component may be identified based on the changeable visual indicator changing according to the defined pattern. For example, if the changeable visual indicator of a particular component is caused to be changed according to a specific defined pattern, and the captured images depict one of the components with a changeable visual indicator changing according to the specific defined pattern (e.g., while other changeable visual indicators are not changing according to the specific defined pattern), then the particular component may be identified in the images.

In some implementations, one or more of the other electronic components may also be identified based on a similar analysis, e.g., based on the respective changeable visual indicators changing according to respective defined patterns. In such cases, multiple electronic components may be identified sequentially, e.g., one at a time, or in parallel, e.g., multiple components being identified at the same time. In cases where the electronic components are to be identified sequentially, a like defined pattern may utilized, and the electronic components may be identified based on the timing of when the pattern is being exhibited by the visual indicator of a particular electronic component. In cases where the electronic components are to be identified in parallel, unique defined patterns may be utilized, such that the specific pattern being exhibited by the respective visual indicators of respective electronic components is used to distinguish the electronic components from one another.

In implementations where multiple electronic components are identified, a mapping of the electronic components may be generated. The mapping may include, for example, relative position information associated with the various electronic components identified at block 530.

At block 540, an augmented reality scenario associated with the identified electronic component is presented. The augmented reality scenario may be displayed as a visual overlay to the captured images, and may include information about one or more of the identified components and/or information associated with servicing such components. In cases where multiple electronic components are identified, multiple augmented reality scenarios may be presented. The augmented reality scenarios may be configurable and/or implementation-specific, and different or similar augmented reality scenarios may be presented for different types of identified electronic components.

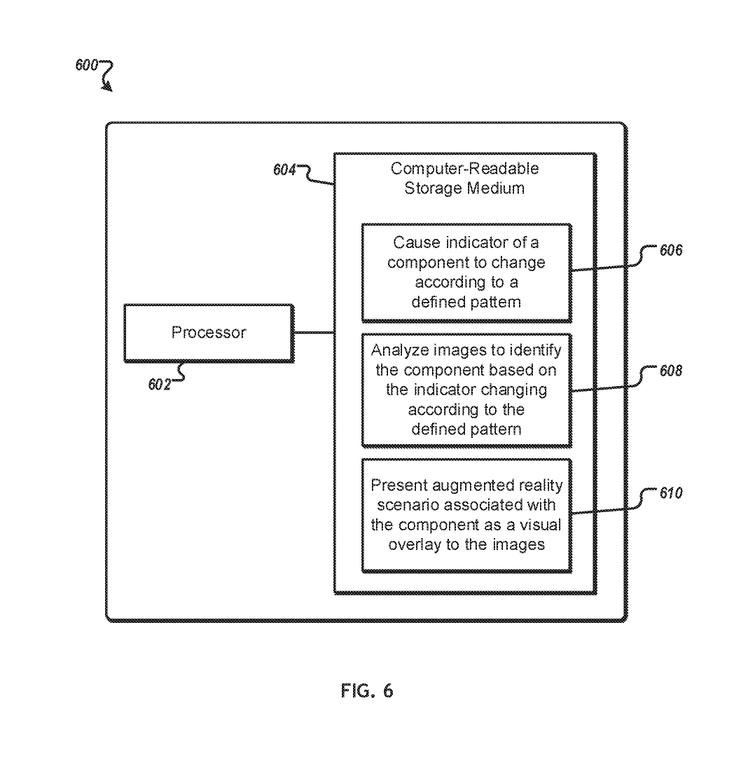

FIG. 6 is a block diagram of an example computing system 600 that includes a computer-readable storage medium with instructions to identify electronic components for augmented reality. Computing system 600 includes a processor resource 602 and a machine-readable storage medium 604.

Processor resource 602 may include a central processing unit (CPU), microprocessor (e.g., semiconductor-based microprocessor), and/or other hardware device suitable for retrieval and/or execution of instructions stored in machine-readable storage medium 604. Processor resource 602 may fetch, decode, and/ or execute instructions 606, 608, and 610 to identify electronic components for augmented reality, as described below. As an alternative or in addition to retrieving and/or executing instructions, processor resource 602 may include an electronic circuit comprising a number of electronic components for performing the functionality of instructions 606, 608, and 610.

Machine-readable storage medium 604 may be any suitable electronic, magnetic, optical, or other physical storage device that contains or stores executable instructions. Thus, machine-readable storage medium 604 may include, for example, a random-access memory (RAM), an Electrically Erasable Programmable Read-Only Memory (EEPROM), a storage device, an optical disc, and the like. In some implementations, machine-readable storage medium 604 may include a non-transitory storage medium, where the term “non-transitory” does not encompass transitory propagating signals. As described below, machine-readable storage medium 604 may be encoded with a set of executable instructions 606, 608, and 610.

Instructions 606 may cause an indicator, e.g., a first dynamic visual indicator, of a component, e.g., a first electronic component, to change according to a defined pattern, e.g., a first defined pattern. Instructions 608 may analyze images, e.g., captured images that depict the first electronic component and other electronic components, to identify the component, e.g., the first electronic component, based on the indicator changing according to the defined pattern. Instructions 610 may present, e.g., on a display of a computing device, an augmented reality scenario associated with the identified component. The augmented reality scenario may be presented by instructions 610 as a visual overlay to the captured images.

In some implementations, the machine-readable storage medium 604 may also be encoded with other executable instructions to carry out other portions of the functionality described above. For example, machine-readable storage medium 604 may further include instructions causing a second dynamic visual indicator of a second electronic component to change according to a second defined pattern, and to analyze the captured images to identify the second electronic component based on the second dynamic visual indicator changing according to the second defined pattern.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A method comprising:
causing, using a computing device, a first changeable visual indicator of a first electronic component to change according to a defined pattern;
capturing, using an image capture mechanism of the computing device, images that depict the first electronic component and other electronic components within a field of view of the image capture mechanism;
analyzing, using the computing device, the captured images to identify the first electronic component from among the other electronic components based on the first changeable visual indicator changing according to the defined pattern; and
presenting, using the computing device, an augmented reality scenario associated with the first electronic component, the augmented reality scenario being presented on a display of the computing device as a visual overlay to the captured images.

2. The method of claim 1 further comprising causing respective changeable visual indicators of the other electronic components depicted in the captured images to change according to respective defined patterns, and analyzing the captured images to identify the other electronic components based on the respective changeable visual indicators changing according to the respective defined patterns.

3. The method of claim 2, further comprising generating a mapping of the first electronic component and the other electronic components, the mapping comprising relative position information associated with the first electronic component and the other electronic components.

4. The method of claim 2, wherein the first electronic component and the other electronic components are identified sequentially, with each changeable visual indicator changing according to a like defined pattern.

5. The method of claim 2, wherein the first electronic component and the other electronic components are identified in parallel, with each changeable visual indicator changing according to a unique defined pattern.

6. The method of claim 1, wherein the Out changeable visual indicator comprises a light emitting diode (LED).

7. The method of claim 6, wherein the first changeable visual indicator comprises multiple LEDs.

8. The method of claim 1, wherein the defined pattern comprises flashing the first changeable visual indicator on and off at a constant frequency for a period of time.

9. The method of claim 1, wherein the defined pattern comprises a change in color of the first changeable visual indicator.

10. The method of claim 1, wherein the first changeable visual indicator is caused to be changed by a controller associated with the first electronic component, the controller being in electronic communication with the computing device.

11. A system comprising:
a processor resource;
an image capture device to capture images of an electronic system that includes a plurality of electronic components each having a dynamic visual indicator;
a pattern analyzer executable on the processor resource to recognize respective patterns of changes in the respective dynamic visual indicators;
a component mapper executable on the processor resource to generate a mapping of the plurality of electronic components, the mapping comprising relative position information associated with the plurality of electronic components, the mapping being generated based on the recognized respective patterns of changes in the respective dynamic visual indicators; and
an augmented reality engine executable on the processor resource to present an augmented reality scenario associated with at least one of the plurality of electronic components, the augmented reality scenario being presented as a visual overlay to the captured images.

12. The system of claim 11, wherein the plurality of electronic components are mapped sequentially, with each dynamic visual indicator being changed according to a like pattern.

13. The system of claim 11, wherein the plurality of electronic components are mapped in parallel, with each dynamic visual indicator being changed according to a unique pattern.

14. A non-transitory computer-readable storage medium storing instructions that, when executed by a processor resource, cause the processor resource to:
cause a first dynamic visual indicator of a first electronic component to change according to a first defined pattern;
analyze captured images that depict the first electronic component and other electronic components to identify the first electronic component from among the other electronic components based on the first dynamic visual indicator changing according to the first defined pattern; and
present, on a display of a computing device, an augmented reality scenario associated with the first electronic component, the augmented reality scenario being presented as a visual overlay to the captured images.

15. The non-transitory computer-readable storage medium of claim 14, further storing instructions that cause the processor resource to cause a second dynamic visual indicator of a second electronic component from among the other electronic components to change according to a second defined pattern, and to analyze the captured images to identify the second electronic component based on the second dynamic visual indicator changing according to the second defined pattern.
